(19) United States
(12) Patent Application Publication
(10) Pub. No.: US 2006/0053709 A1
(43) Pub. Date: Mar. 16, 2006

(54) Panel having interlocking folds used as interior or exterior finishing material for buildings

(76) Inventor: Yee-Hyeng Kim, Gyeongsangbuk-do (KR)

Correspondence Address: BOOTH UDALL, PLC, 1423 S. HIGLEY ROAD, SUITE 110, MESA, AZ, 85206, US

(21) Appl. No.: 10/540,500

(22) PCT Filed: Jun. 21, 2004
(86) PCT No.: PCT/KR04/01489

§ 371 Date: Jun. 23, 2005

(30) Foreign Application Priority Data
Jun. 26, 2003 (KR) 2020030020261

(51) Int. Cl. E06B 7/14

(52) U.S. Cl. 52/204.52

(57) ABSTRACT

A panel having interlocking folds which is used as an interior or exterior finishing material for buildings. The panel is easily installed on a support surface, and has a function of preventing a backflow of water into gaps between the interlocking folds of seamed panels by wind action. The panel includes a tetragonal panel body (1), two outer interlocking folds (3) provided by folding outwardly two neighboring sides of the panel body to extend in parallel to a surface of the panel body, two inner interlocking folds (5) provided by folding inwardly two remaining sides, opposite to the outer interlocking folds, to extend in parallel to the opposite surface, and a locking part (7) provided at a corner between the two outer interlocking folds to be fastened to a support surface by a locking nail.

### TECHNICAL FIELD

The present invention relates, in general, to panels having interlocking folds which are used as interior and exterior finishing materials for buildings and more particularly, to a panel having interlocking folds which is used as an interior or exterior finishing material for buildings, and is easily installed on a roof or on an indoor or outdoor wall surface of a building to provide a decorative roofing or wall covering, with a function of preventing a backflow of water into gaps between the interlocking folds of seamed panels by wind action.

### BACKGROUND ART

Generally, buildings are fabricated with columns, walls and roofs, which protect the interiors of the buildings from the outdoor environment and thereby provide comfortable indoor spaces to inhabitants. To accomplish the above-mentioned functions of the buildings, the roofs, and the indoor and outdoor wall surfaces must be constructed to have thermal-insulating and water-resistant structures. Furthermore, typically, the roofs and the indoor and outdoor wall surfaces of buildings are covered with decorative interior and exterior finishing materials to provide attractive appearances of the buildings, resulting in beautification of residential areas, towns and cities where the buildings are placed.

In the related art, a variety of stone panels and metal panels have been proposed as the interior and exterior finishing materials for buildings. Of the conventional interior and exterior finishing panels for buildings, the stone panels are problematic in that an installation thereof on a building must be accompanied by an additional sealing process to seal the joints of the panels, thus causing a difficulty during a process of installing the stone panels. Furthermore, the stone panels are heavy, so that workers suffer exhaustion and injury while handling the stone panels.

Thus, in place of the stone panels having the above-mentioned problems, metal panels have been preferably used in recent years. The metal panels as the interior and exterior finishing materials for buildings are purchased at low costs, quickly installed and provide more beautiful appearances to buildings, in comparison with the stone panels. Thus, many consumers prefer the metal panels to the stone panels.

Most conventional metal panels, which have been proposed as the interior and exterior finishing materials for buildings, are constructed as types to be seamed together through a fold-interlocking manner. In a detailed description, each of the conventional metal panels to be seamed together through the fold-interlocking manner comprises a rectangular, square or rhombic panel body, of which two neighboring sides are folded outwardly to provide outer interlocking folds, and to remaining sides are folded inwardly to provide inner interlocking folds.

Thus, when installing a plurality of metal panels having the interlocking folds on a support surface, one of the two outer interlocking folds of a metal panel interlocks with one of the two inner interlocking folds of another metal panel, thus seaming the too metal panels together. The above-mentioned interlocking of the outer and inner interlocking folds is repeated to provide a fold-interlocking structure. Thus, the fold-interlocking metal panels provide a decorative roofing or a decorative wall covering.

In the above state, to fasten the fold-interlocking metal panels as the interior and exterior finishing materials for buildings to a roof or an indoor or outdoor wall surface, locking brackets as well as locking nails must be used.

However, because the conventional metal panels having the interlocking folds, used as the interior and exterior finishing materials for buildings, must be fastened to the roof or the indoor or outdoor wall surface by means of locking brackets as well as locking nails, the metal panels require many locking members, causing a problem in that the process of installing the metal panels is complicated.

Furthermore, fine gaps unavoidably remain in the outer and inner interlocking folds of the seamed conventional metal panels used as the interior and exterior finishing materials of a building. Thus, the conventional metal panels are problematic in that the metal panels cannot prevent a backflow of water into gaps between the interlocking folds of the seamed panels by wind action.

### DISCLOSURE OF INVENTION

### TECHNICAL SOLUTION

Accordingly, the present invention has been made keeping in mind the above problems occurring in the prior art, and an object of the present invention is to provide a panel having interlocking folds which is used as an interior or exterior finishing material for buildings, and simplifies the construction of a locking part thereof thus being easily installed on a roof or on an indoor or outdoor wall surface of a building and which prevents a backflow of water into gaps defined between the interlocking folds of seamed metal panels.

In order to accomplish the above object, the present invention provides a panel having interlocking folds which is used as an interior or exterior finishing material for buildings, comprising: a panel body having a tetragonal sheet shape; outer interlocking folds provided on a surface of the panel body by folding outwardly too neighboring sides of the panel body so that the outer interlocking folds extend in parallel to the surface of the panel body; inner interlocking folds provided on an opposite surface of the panel body by folding inwardly two remaining sides of the panel body opposite to the outer interlocking folds so that the inner interlocking folds extend in parallel to the opposite surface of the panel body; and a locking part to be fastened to a support surface by a locking nail, the locking part being provided on a corner of the panel body between the outer interlocking folds or the inner interlocking folds while diagonally extending on a same plane as that of the panel body.

In the panel, the outer interlocking folds may be provided with a backflow prevention cap to guide water to the panel body while preventing a backflow of the water driven by wind into gaps defined between the outer interlocking folds of the panel and corresponding inner interlocking folds of neighboring panels that interlock with the outer interlocking folds of the panel.

In the panel, both the panel body and the outer interlocking folds may be coated on outer surfaces thereof with stone powders.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing the construction of a panel having interlocking folds, which is used as an interior or exterior finishing material for buildings, according to an embodiment of the present invention;

FIG. 2 is a development view of the panel according to the embodiment of the present invention;

FIG. 3 is a perspective view showing a fold-interlocking method of seaming two panels according to the embodiment of the present invention together;

FIG. 4 is a plan view of a plurality of panels according to the embodiment of the present invention, which are seamed together through the fold-interlocking method;

FIGS. 5a, 5b and 5c are perspective views respectively showing backflow prevention caps used with the panel having the interlocking folds, according to different modifications of the embodiment of the present invention; and

FIG. 6 is a perspective view showing the construction of a panel having interlocking folds, which is used as an interior or exterior finishing material for buildings, according to another embodiment of the present invention.

### BEST MODE FOR CARRYING OUT THE INVENTION

Reference should now be made to the drawings, in which the same reference numerals are used throughout the different drawings to designate the same or similar components.

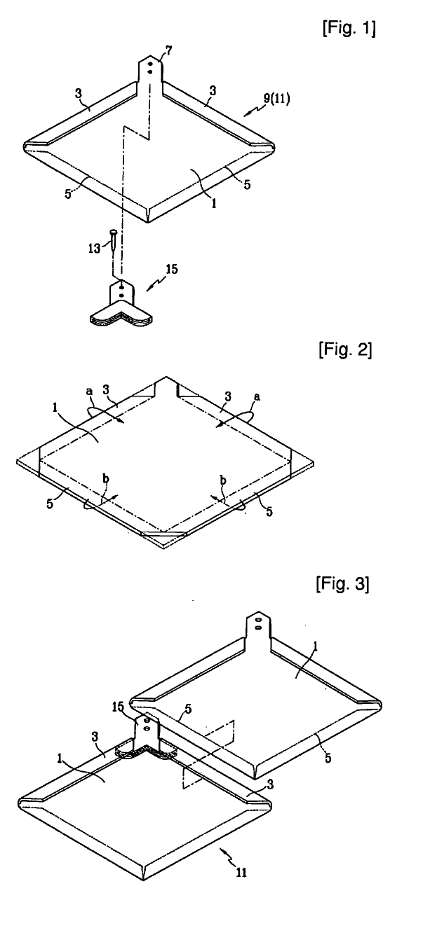

FIG. 1 is a perspective view showing the construction of a panel having interlocking folds, which is used as an interior or exterior finishing material for buildings, according to an embodiment of the present invention. As shown in the drawing, the panel of the present invention comprises a panel body 1 having a tetragonal sheet shape with four equal sides. The panel further comprises two outer interlocking folds 3, two inner interlocking folds 5, and a locking part 7 which are provided on the panel body 1.

The panel body 1 defines a base body of the panel, and is preferably constructed to have a rhombic or square shape. However, it should be understood that the body 1 may be constructed in the form of a rectangular shape, without affecting the functioning of the present invention. When installing the panel on a building the panel body 1 is placed on a roof or on an indoor or outdoor wall surface of the building so that two diagonal axes of the panel body 1 are respectively aligned along vertical and horizontal lines on the roof or the wall surface. Thus, the bodies 1 of a plurality of panels can continuously interlock together while being continuously arranged along oblique lines on the roof or the indoor or outdoor wall surface. To accomplish the above-mentioned continuous interlocking of the panel bodies 1, each of the panel bodies 1 is provided with the two outer interlocking folds 3 and the two inner interlocking folds 5.

To provide the two outer interlocking folds 3, two neighboring sides of the panel body 1 around an apex are folded forwardly. In a detailed description, to provide the two outer interlocking folds 3, specified parts around the four apexes of the panel body 1 are appropriately cut off as shown by the dotted lines in FIG. 2, so that the locking part 7 is provided at a top corner of the panel body 1. Thereafter, two neighboring sides of the panel body 1 around the locking part 7 are folded outwardly as shown by the arrows ‘a’ in the drawing thus providing the two outer interlocking folds 3 which extend in parallel to a surface of a remaining part of the panel body 1. In the above state, the locking part 7 remains at the top corner between the two outer interlocking folds 3 while diagonally extending on a same plane as that of the panel body 1.

In the meantime, the two inner interlocking folds 5 are provided on an opposite surface of the panel body 1 so that the location of the two inner interlocking folds 5 is opposite to that of the too outer interlocking folds 3. In a detailed description, to provide the two inner interlocking folds 5, two remaining sides of the panel body 1 which are opposite to the above-mentioned two neighboring sides for the outer interlocking folds 3, in other words, the two neighboring sides around a bottom corner of the panel body 1 opposite to the locking part 7 are folded inwardly as shown by the arrows ‘b’ in the drawing, thus providing the two inner interlocking folds 3 which extend in parallel to the opposite surface of the panel body 1.

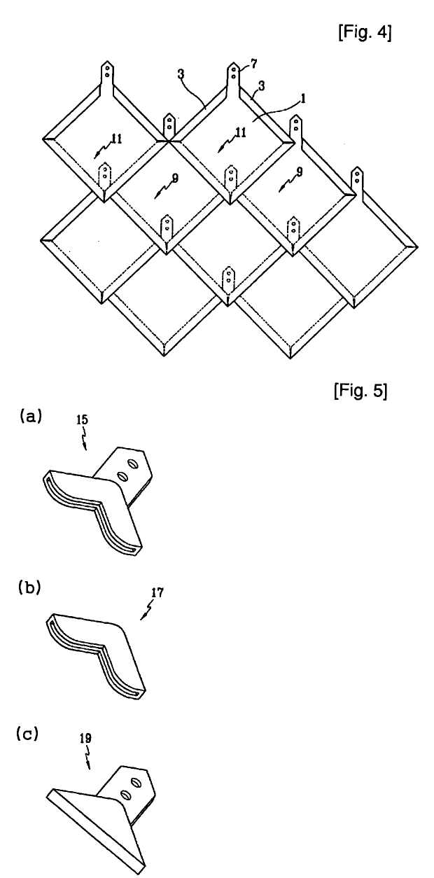

As shown in FIG. 3, to seam a plurality of panels together through a fold-interlocking method one of the two outer interlocking folds 3 of a first panel 9 interlocks with one of the two inner interlocking folds 5 of a second panel 11. Furthermore, one of the two inner interlocking folds 3 of the first panel 9 interlocks with one of the two outer interlocking folds 5 of a third panel. When the above-mentioned fold-interlocking of the panels is repeated on a roof or on an indoor or outdoor wall surface, a decorative roofing or a decorative wall covering is provided as shown in FIG. 4.

In the above state, the locking part 7 is fastened to the roof or the indoor or outdoor wall surface by means of a locking nail 13. Thus, the bodies 1 of the panels which interlock with each other at the outer and inner interlocking folds 3 and 5 thereof are easily fastened to the roof or the indoor or outdoor wall surface.

In a detailed description, because the locking part 7 of each panel is provided at a position around the top corner between the two outer interlocking folds 3 while extending in a vertical direction aligned with one of the two diagonal axes of the panel body 1, each of the panels 9 and 11 is easily and simply fastened to the roof or the indoor or outdoor wall surface through a single process of driving the locking nail 13 at the locking part 7. In the present invention, the number of locking nails 13 used for fastening each of the panels 9 and 11 to the roof or the indoor or outdoor wall surface is preferably set to one or two in response to the size of the panel body 1.

A backflow prevention cap 15 is preferably installed in the panel so that the cap 15 is inserted into facing ends of the two outer interlocking folds 3 of a panel around the locking part 7 to close the ends as shown in FIG. 1. In the above state, the backflow prevention cap 15 also covers the locking part 7 and closes corresponding ends of inner interlocking folds 3 of two neighboring panels that interlock with the outer interlocking folds 3 of the panel.

The backflow prevention cap 15 is constructed to prevent a backflow of water driven by wind from the panel body 1 of each panel into the gaps between the outer interlocking folds 3 of the panel and the inner interlocking folds 5 of neighboring panels that interlock with the outer interlocking panels 3. In a detailed description, the outer and inner interlocking folds 3 and 5 of seamed panels closely interlock with each other, but the gaps unavoidably remain in the interlocking outer and inner interlocking folds 3 and 5 of the seamed panels. Thus, water, which drops onto the panel body 1 or the outer interlocking folds 3 of a panel, may reverse-flow into the gaps between the outer and inner interlocking folds 3 and 5 of the seamed panels by wind action so that the water may be introduced into the roof or the indoor or outdoor wall surface. However, the backflow prevention cap 15 of the present invention prevents such a backflow of water driven by wind into the gaps between the outer and inner interlocking folds 3 and 5 of the seamed panels, but guides the water onto the outer surface of the panel body 1.

The backflow prevention cap 15 of the present invention may be variously constructed as shown in FIGS. 5a, 5b and 5c. The backflow prevention cap 15 of FIG. 5a is equal to the cap that is shown in FIG. 1 and is fastened to a support surface by means of a locking nail 13. The backflow prevention cap 17 of FIG. 5b may be fitted into the facing ends of the two outer interlocking folds 5 of a panel before two corresponding inner interlocking folds 3 of two neighboring panels interlock with the outer interlocking folds 3 of the panel having the cap 17. Alternatively, the backflow prevention cap 17 of FIG. 5b may be supported in the facing ends of the two outer interlocking folds 3 of the panel body 1 using an appropriate adhesive. Each of the backflow prevention caps 15 and 17 of FIGS. 5a and 5b prevents a backflow of water into the gaps between the outer and inner interlocking folds of the seamed panels, and, furthermore, guides the water onto the outer surface of the panel body 1. In the meantime, the backflow prevention cap 19 of FIG. 5c has a function of only preventing the backflow of water into the gaps between the outer and inner interlocking folds 5 of the seamed panels. The backflow prevention cap 19 of FIG. 5c is fastened to a support surface by means of a locking nail 13 in the same manner as that described for the backflow prevention cap 15 of FIG. 5a.

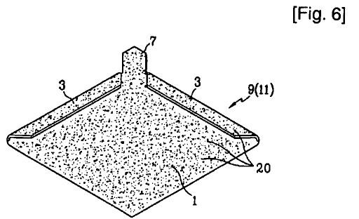

As shown in FIG. 6, each of the panels 9 and 11 may be produced in the form of a stone powder-coated structure, in which stone powders 20 are coated on the outer surfaces of both the panel body 1 and the outer interlocking folds 3 of the panel. The stone powders 20 may have various colors to enhance the decoration effect of the panel used as a decorative interior or exterior finishing material for buildings.

### INDUSTRIAL APPLICABILITY

As described above, the present invention provides a panel having interlocking folds that is used as an interior or exterior finishing material for buildings. The panel is provided with too outer interlocking folds on a surface thereof and two inner interlocking folds on an opposite surface thereof, with a locking part provided at a position between the two outer interlocking folds so that the locking part extends on a same plane as that of a panel body. Thus, in comparison with a conventional panel that is fastened to a roof or an indoor or outdoor wall surface of a building by means of a locking bracket, the panel of the present invention is more easily simply fastened to the roof or the indoor or outdoor wall surface through a single process of driving a locking nail at the locking part. Thus, the present invention simplifies the process of installing the panels on a roof or on an indoor or outdoor wall surface of a building. Furthermore, a backflow prevention cap is used for covering the locking part and, at the same time, closing the facing ends of the outer interlocking folds of the panel around the locking part, so that the backflow prevention cap effectively prevents a backflow of water driven by wind into gaps between the inner and outer interlocking folds of seamed panels that interlock with each other, different from a conventional panel which does not have such a backflow prevention cap.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A panel having interlocking folds which is used as an interior or exterior finishing material for buildings, comprising:
a panel body having a tetragonal sheet shape;
outer interlocking folds provided on a surface of the panel body by folding outwardly two neighboring sides of the panel body so that the outer interlocking folds extend in parallel to the surface of the panel body;
inner interlocking folds provided on an opposite surface of the panel body by folding inwardly two remaining sides of the panel body opposite to the outer interlocking folds so that the inner interlocking folds extend in parallel to the opposite surface of the panel body; and
a locking part to be fastened to a support surface by a locking nail, the locking part being provided at a corner of the panel body between the outer interlocking folds or the inner interlocking folds while diagonally extending on a same plane as that of the panel body.

2. The panel according to claim 1, wherein the outer interlocking folds are provided with a backflow prevention cap to guide water to the panel body while preventing a backflow of the water driven by wind into gaps defined between the outer interlocking folds of the panel and corresponding inner interlocking folds of neighboring panels that interlock with the outer interlocking folds of the panel.

3. The panel according to claim 1 or 2, wherein both the panel body and the outer interlocking folds are coated on outer surfaces thereof with stone powders.
